(19) United States
(12) Patent Application Publication
(10) Pub. No.: US 2012/0008515 A1
(43) Pub. Date: Jan. 12, 2012

(54) APPARATUS AND METHOD FOR REDUCING MESSAGE TRANSMISSION OVERHEAD IN WIRELESS COMMUNICATION SYSTEM

(75) Inventor: So-Ra Jung, Suwon-si (KR)

(73) Assignee: SAMSUNG ELECTRONICS CO., LTD., Suwon-si (KR)

(21) Appl. No.: 13/179,108

(22) Filed: Jul. 8, 2011

(30) Foreign Application Priority Data
Jul. 9, 2010 (KR) 10-2010-0066132

(51) Int. Cl. H04W 88/04; H04W 24/00

(52) U.S. Cl. 370/252; 370/315

(57) ABSTRACT

An apparatus and a method for reducing a message transmission overhead in a wireless communication system that supports a Service Discovery Protocol (SDP). In the method, when a service discovery request message is received from a neighbor node, a hop count of the service discovery request message is determined. A maximum hop count of an advertisement message is determined with consideration of the hop count of the service discovery request message.

### CROSS-REFERENCE TO RELATED APPLICATION(S) AND CLAIM OF PRIORITY

The present application is related to and claims priority under 35 U.S.C. §119(a) of a Korean patent application filed in the Korean Intellectual Property Office on Jul. 9, 2010 and assigned Serial No. 10-2010-0066132, the entire disclosure of which is hereby incorporated by reference.

### TECHNICAL FIELD OF THE INVENTION

The present invention relates to a wireless communication system. More particularly, the present invention relates to an apparatus and a method for providing a Service Discover Protocol (SDP) suitable for a wireless network environment in a wireless communication system.

### BACKGROUND OF THE INVENTION

A Mobile Ad hoc Network (MANET) includes mobile devices that support a wireless interface such as a Personal Digital Assistant (PDA), a smart phone, a Wireless Local Area Network (WLAN), Bluetooth, and the like.

Mobile devices that have accessed the same MANET environment may share contents such as images, sounds, and videos with other mobile devices accessible within the same network. Accordingly, the MANET should support stable connections between mobile devices connected within the network.

The environment of the MANET is dynamic. That is, no fixed infrastructure and no central manage node exist in the MANET, so that connection and release between mobile devices connected to the network are freely performed. Accordingly, the MANET cannot predict the number of nodes connected to the network. In addition, a mobile device is limited in using resources such as limited power consumption caused by a limited battery, a relatively smaller network bandwidth than a wired device, and a limited memory capacity.

Therefore, the MANET needs a Service Discovery Protocol (SDP) suitable for a wireless network environment.

### SUMMARY OF THE INVENTION

To address the above-discussed deficiencies of the prior art, it is a primary object to provide at least the advantages described below. Accordingly, an aspect of the present invention is to provide an apparatus and a method for providing an SDP suitable for a wireless environment in a wireless communication system.

Another aspect of the present invention is to provide an apparatus and a method for providing an SDP suitable for a wireless environment in an MANET.

Still another aspect of the present invention is to provide an apparatus and a method for reducing a message overhead caused by an SDP in an MANET.

Yet another aspect of the present invention is to provide an apparatus and a method for reducing a message overhead caused by a Simple Service Discovery Protocol (SSDP) of a Universal Plug and Play (UPnP) in an MANET.

Yet another aspect of the present invention is to provide an apparatus and a method for determining a maximum hop count of an advertisement message depending on a hop count of an SDP in a MANET

In accordance with an aspect of the present invention, a method for determining a maximum hop count of an advertisement message in a service provide node of a wireless communication system that supports a Service Discovery Protocol (SDP) is provided. The method includes, when a service discovery request message is received from a neighbor node, determining a hop count of the service discovery request message. The method also includes determining a maximum hop count of the advertisement message with consideration of the hop count of the service discovery request message. The hot count of the service discovery request message includes a hop count from a request node that has generated the service discovery request message up to the service provide node.

In accordance with another aspect of the present invention, a method for transmitting a message in a wireless node of a wireless communication system that supports a Service Discovery Protocol (SDP) is provided. The method includes, when a service discovery request message is received from a neighbor node, determining service information of the service discovery request message. The method also includes determining whether advertisement information corresponding to the service information is included. The method further includes, when the advertisement information corresponding to the service information is included, transmitting the service discovery request message to at least one neighbor node including the advertisement information. The service information includes at least one of a service whose discovery is requested by a request node that has generated the service discovery request message, and service provide node information that provides the service. The advertisement information includes information of a service provide node included in an advertisement message provided by at least one neighbor node.

In accordance with still another aspect of the present invention, an apparatus for determining a maximum hop count of an advertisement message in a service provide node of a wireless communication system that supports a Service Discovery Protocol (SDP) is provided. The apparatus includes a receiver configured to receive a signal, and a hop count determination unit configured, when a service discovery request message is received from a neighbor node via the receiver, to determine the maximum hop count of the advertisement message with consideration of a hop count of the service discovery request message. The hop count of the service discovery request message includes a hop count from a request node that has generated the service discovery request message up to the service provide node.

In accordance with yet another aspect of the present invention, an apparatus for transmitting a message in a wireless node of a wireless communication system that supports a Service Discovery Protocol (SDP) is provided. The apparatus includes a receiver for receiving a signal. The apparatus also includes a controller configured, when a service discovery request message is received from a neighbor node via the receiver, to determine whether advertisement information corresponding to service information of the service discovery request message is included, and when the advertisement information corresponding to the service information is included, to control to transmit the service discovery request message to at least one neighbor node including the advertisement information. The apparatus further includes a transmitter configured to transmit the service discovery request message under control of the controller. The service information includes at least one of a service whose discovery is requested by a request node that has generated the service discovery request message, and service provide node information that provides the service. The advertisement information includes information of a service provide node included in an advertisement message provided by at least one neighbor node.

Other aspects, advantages and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a view illustrating a wireless communication system according to an embodiment of the present invention;

FIG. 2 is a flowchart illustrating a procedure for transmitting a discovery request message in a wireless node connected to a wireless communication system according to an embodiment of the present invention;

FIG. 3 is a flowchart illustrating a procedure for transmitting a discovery request message in a node connected to a wireless communication system according to an embodiment of the present invention;

FIG. 4 is a flowchart illustrating a procedure for updating a maximum hop count in a service provide node of a wireless communication system according to an embodiment of the present invention;

FIG. 5 is a block diagram illustrating a wireless node in a wireless communication system according to an embodiment of the present invention; and

FIG. 6 is a block diagram illustrating a service provide node in a wireless communication system according to an embodiment of the present invention.

Throughout the drawings, like reference numerals will be understood to refer to like parts, components and structures.

### DETAILED DESCRIPTION OF THE INVENTION

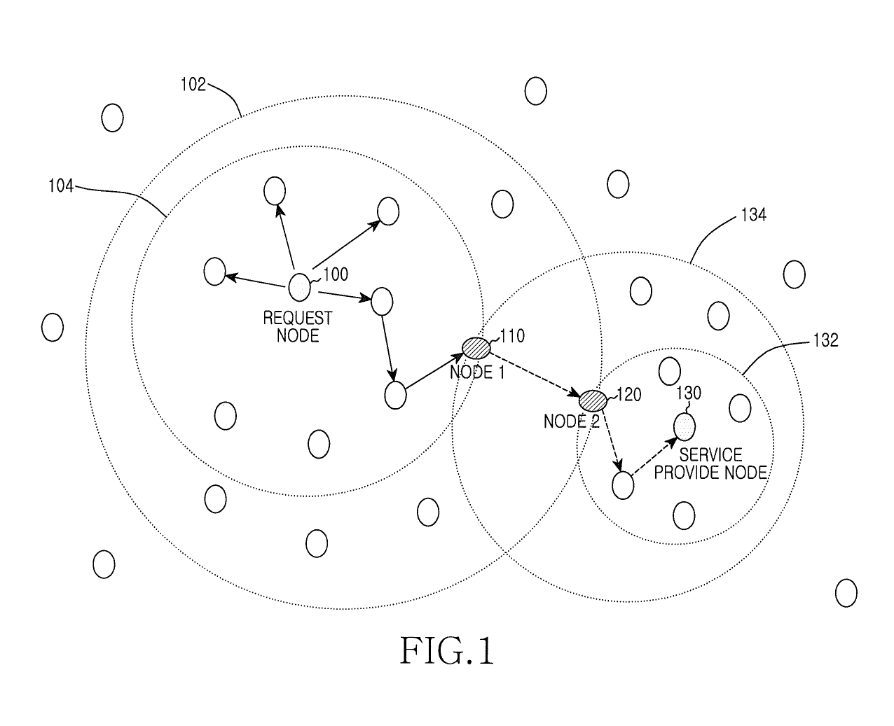

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Embodiments of the present invention will be described herein below with reference to the accompanying drawings. In the following description, well-known functions or constructions are not described in detail since they would obscure the invention in unnecessary detail. Terms described below, which are defined considering functions in the present invention, can be different depending on user and operator's intention or practice. Therefore, the terms should be defined on the basis of the disclosure throughout this specification.

Exemplary embodiments of the present invention provide a technology for providing an SDP suitable for a wireless network environment in a wireless communication system.

Nodes connected to the same wireless network may share contents such as images, sounds, videos, and the like. For example, wireless nodes may support inter-node connection based on an SDP of a UPnP. In the following description, it is assumed that a Simple SDP (SSDP) function of the UPnP is improved, so that the inter-node connection is supported. Here, the SSDP is for discovering a service provide node in a networking step of a UPnP, and is a global directory-less multicast-based protocol.

In the following description, the SSDP transmits a service discovery request message and an advertisement message via a P2P overlay network. Here, the P2P overlay network is an application layer and denotes a network that provides connection, routing, and messaging between addressable end points.

FIG. 1 is a view illustrating a wireless communication system according to an embodiment of the present invention.

As illustrated in FIG. 1, when requesting discovery of a service provided by a service provide node 130, the request node 100 broadcasts a service discovery request message to the neighborhood. That is, the request node 100 transmits a service discovery request message to all neighbor nodes located in a one-hop range.

A node that has received the service discovery request message determines whether the node includes service information whose discovery is requested by the request node 100. When the node does not include the service information whose discovery is requested by the request node 100, the node broadcasts the service discovery request message to the neighborhood. In contrast, when the node includes the service information whose discovery is requested by the request node 100, the node transmits the service discovery request message to at least one neighbor node including the service information whose discovery is requested by the request node 100. For example, when the node 1 110 includes the service information whose discovery is requested by the request node 100, the node 1 110 transmits the service discovery request message to a node 2 120 including the service information whose discovery is requested by the request node 100. At this point, the node 1 110 and the node 2 120 determine service information of a service provide node 130 via an advertisement message of the service provide node 130. Here, the service information includes information of a service whose discovery is requested by the request node 100 and the service provide node 130 that provides a relevant service.

Accordingly, the range in which the service discovery request message is transmitted is determined depending on a range in which the service provide node 130 broadcasts an advertisement message. For example, when the advertisement message of the service provide node 130 is broadcasted up to a first advertisement range 132, the service discovery request message is broadcasted up to a first broadcast range 102. In this situation, the request node 100 may set a maximum hop count of the service discovery request message and a transmission time so that the service discovery request message may be broadcasted up to the first broadcast range 102. For another example, when the advertisement message of the service provide node 130 is broadcasted up to a second advertisement range 134, the service discovery request message is broadcasted up to a second broadcast range 104. In this situation, the request node 100 may set a maximum hop count of the service discovery request message and an accumulation broadcast time so that the service discovery request message may be broadcasted up to the second broadcast range 104.

As described above, as the range in which the advertisement message of the service provide node is broadcasted increases, the range in which the service discovery request message is broadcasted reduces. That is, as the range in which the advertisement message of the service provide node is broadcasted increases, a frequency in which the service discovery request message is broadcasted reduces.

Hereinafter, a method for transmitting a service discovery request message to a neighbor node at a node that has received the service discovery request message in FIG. 1 is described.

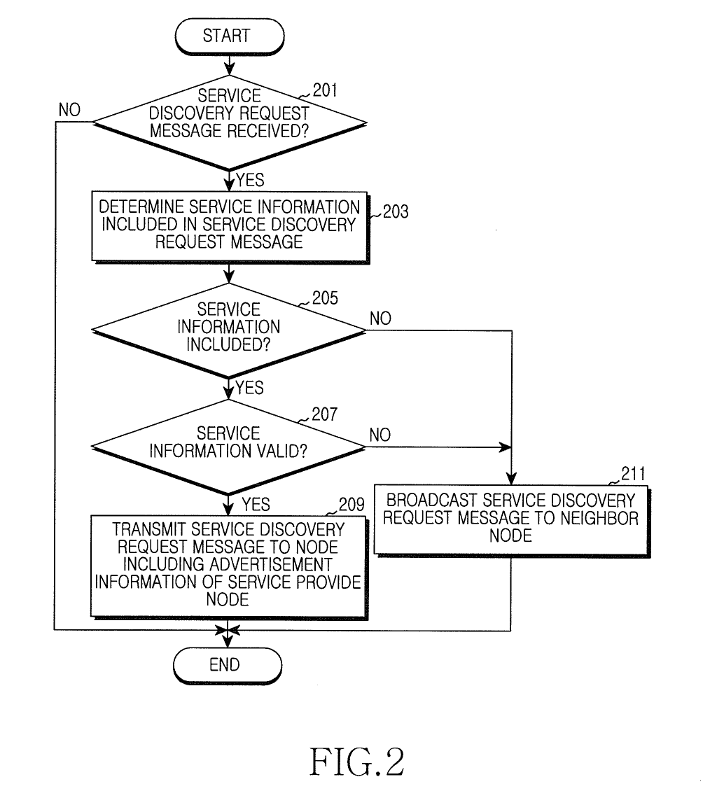

FIG. 2 is a flowchart illustrating a procedure for transmitting a discovery request message in a wireless node connected to a wireless communication system according to an embodiment of the present invention.

Referring to FIG. 2, the wireless node determines whether a service discovery request message is received in step 201.

When the service discovery request message is not received, the wireless node ends the present algorithm.

In contrast, when the service discovery request message is received, the wireless node proceeds to step 203 to determine service information whose discovery is requested by a request node that has transmitted the service discovery request message. Here, the service information includes information of a service whose discovery is requested by the request node and a service provide node that provides a relevant service.

The wireless node proceeds to step 205 to determine whether advertisement information corresponding to the service information determined in step 203 exists among advertisement information stored by the wireless node. Here, the advertisement information denotes service information obtained via an advertisement message that the wireless node has received from the service provide node.

When the advertisement information corresponding to the service information determined in step 203 does not exist, the wireless node proceeds to step 211 to broadcast the service discovery request message to the neighborhood. That is, the wireless node transmits the service discovery request message to all neighbor nodes located in a one-hop range. At this point, the wireless node may not transmit the service discovery request message with consideration of a broadcast range of the service discovery request message. That is, when capable of broadcasting the service discovery request message depending on the broadcast range, the wireless node broadcasts the service discovery request message. In contrast, when not capable of broadcasting the service discovery request message depending on the broadcast range, the wireless node does not broadcast the service discovery request message. Here, the broadcast range of the service discovery request message includes a broadcast depth of a service discovery request message or an accumulated broadcast time. For example, when determining a broadcast range of a service discovery request message with consideration of a broadcast depth, the service discovery request message includes information illustrated in Table 1.

TABLE 1
...
<bcastID> Broadcast ID </bcastID>
<bcastHopCnt>
Current Hop Count of Discovery Request
</bcastHopCnt>
...

Here, <bcastID> denotes identification information of a request node that has transmitted a service discovery request message, and <bcastHopCnt> denotes a broadcast depth of a service discovery request message that a relevant node has received.

In contrast, when the advertisement information corresponding to the service information determined in step 203 exists, the wireless node proceeds to step 207 to determine validity of the advertisement information corresponding to the service information. For example, the wireless node determines validity of relevant advertisement information with consideration of a time at which the wireless node has received an advertisement message last.

When the advertisement information is not valid, the wireless node recognizes that the advertisement information corresponding to the service information determined in step 203 does not exist. Accordingly, the wireless node proceeds to step 211 to broadcast a service discovery request message to the neighborhood. That is, the wireless node transmits the service discovery request message to all neighbor nodes located in a one-hop range. At this point, the wireless node may not broadcast the service discovery request message with consideration of a broadcast range of the service discovery request message.

In contrast, when the advertisement information is valid, the wireless node proceeds to step 209 to transmit the service discovery request message to at least one neighbor node including the advertisement information. That is, the wireless node transmits the service discovery request message to at least one neighbor node that has transmitted an advertisement message including the advertisement information.

After that, the wireless node ends the present algorithm.

In the above embodiment, when two or more neighbor nodes that have transmitted the advertisement message to the wireless node exist, the wireless node multicasts the service discovery request message to the neighbor nodes.

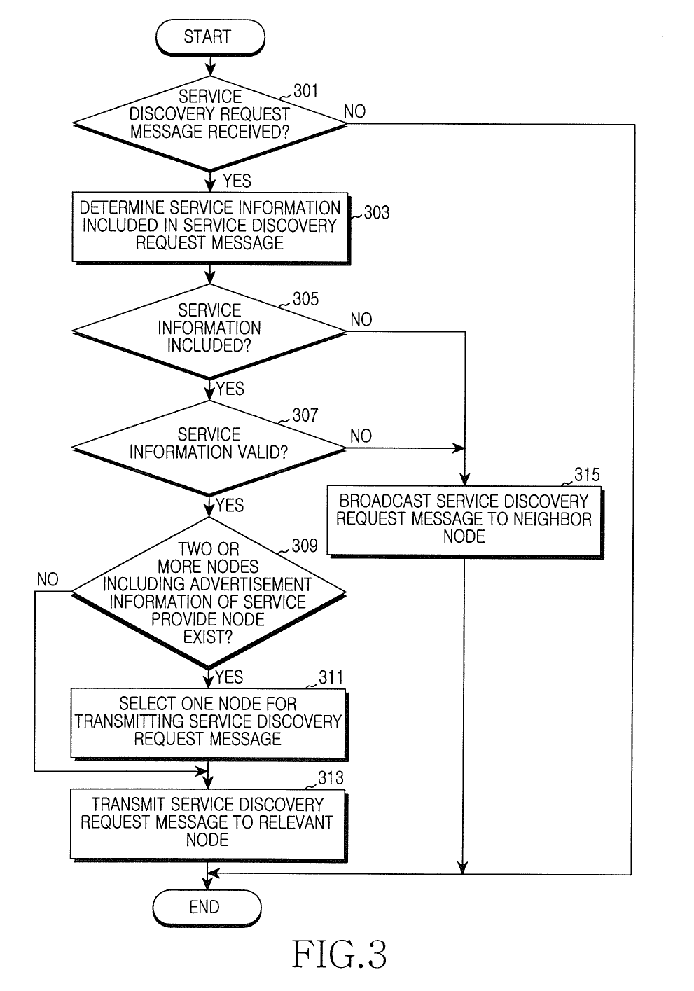

In an embodiment, when two or more neighbor nodes that have transmitted the advertisement message to the wireless node exist, the wireless node may select one neighbor node and unicast the service discovery request message to the selected node as illustrated in FIG. 3.

FIG. 3 is a flowchart illustrating a procedure for transmitting a discovery request message in a node connected to a wireless communication system according to an embodiment of the present invention.

Referring to FIG. 3, the wireless node determines whether a service discovery request message is received in step 301.

When the service discovery request message is not received, the wireless node ends the present algorithm.

In contrast, when the service discovery request message is received, the wireless node proceeds to step 303 to determine service information whose discovery is requested by a request node that has transmitted the service discovery request message. Here, the service information includes information of a service whose discovery is requested by the request node and a service provide node that provides a relevant service.

The wireless node proceeds to step 305 to determine whether advertisement information corresponding to service information determined in step 303 exists among advertisement information stored in the wireless node. Here, the advertisement information denotes service information of the service provide node obtained via an advertisement message that the wireless node has received from the service provide node.

When the advertisement information corresponding to the service information determined in step 303 does not exist, the wireless node proceeds to step 315 to broadcast a service discovery request message to the neighborhood. That is, the wireless node transmits the service discovery request message to all neighbor nodes located in a one-hop range. At this point, the wireless node may not transmit the service discovery request message with consideration of the broadcast range of the service discovery request message. That is, when capable of broadcasting the service discovery request message depending on the broadcast range, the wireless node broadcasts the service discovery request message. In contrast, when not capable of broadcasting the service discovery request message depending on the determined broadcast range, the wireless node does not broadcast the service discovery request message. Here, the broadcast range of the service discovery request message includes a broadcast depth or an accumulated broadcast time of the service discovery request message. For example, when determining the broadcast range of the service discovery request message, the service discovery request message includes information illustrated in Table 1.

In contrast, when the advertisement information corresponding to the service information determined in step 303 exists, the wireless node proceeds to step 307 to determine validity of the advertisement information corresponding to the service information. For example, the wireless node determines validity of relevant advertisement information with consideration of a time at which the wireless node has received an advertisement message from a service provide node last.

When the advertisement information is not valid, the wireless node recognizes that the advertisement information corresponding to the service information determined in step 303 does not exist. Accordingly, the wireless node proceeds to step 315 to broadcast the service discovery request message to the neighborhood. That is, the wireless node transmits the service discovery request message to all neighbor nodes located in a one-hop range. At this point, the wireless node may not transmit the service discovery request message with consideration of a broadcast range of the service discovery request message.

In contrast, when the advertisement information is valid, the wireless node proceeds to step 309 to determine the number of neighbor nodes including the advertisement information. That is, the wireless node determines the number of the neighbor nodes that have transmitted an advertisement message to the wireless node including the advertisement information.

When the number of the neighbor nodes is one, the wireless node proceeds to step 313 to transmit the service discovery request message to a relevant neighbor node.

When the number of the neighbor nodes is two or more, the wireless node proceeds to step 311 to select one neighbor node that has transmitted the service discovery request message from at least two neighbor nodes. For example, the wireless node selects one neighbor node to which the service discovery request message is to be transmitted with consideration of a hop count that has received an advertisement message from the service provide node via a neighbor node and a message overhead of a relevant neighbor node. Accordingly, the advertisement message includes information illustrated in Table 2.

TABLE 2
...
<advID> Advertisement ID </advID>
<advHopCnt>
Current Hop Count of Advertisement
</advHopCnt>
<advMaxHopCnt>
Max Hop Count of Advertisement
</advMaxHopCnt>
...

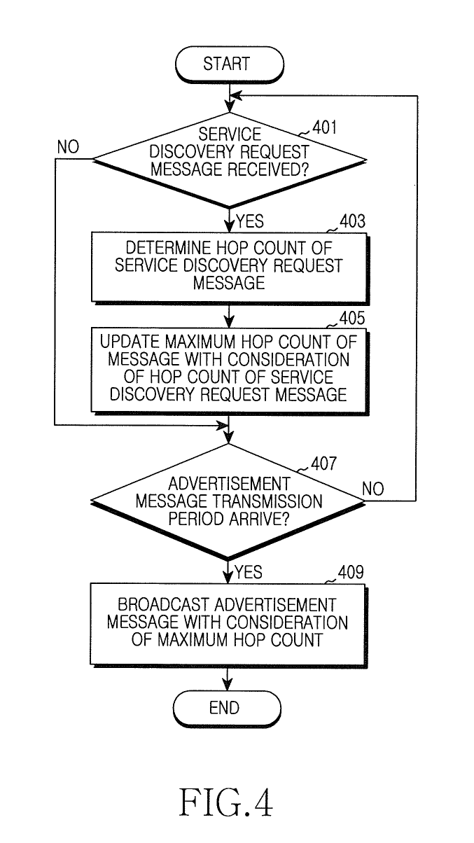

Here, <advID> denotes identification information of a service provide node that has transmitted an advertisement message, <advHopCnt> denotes a broadcast depth of an advertisement message received by a relevant node, and <advMaxHopCnt> denotes a maximum hop count of an advertisement message. Here, the maximum hop count is determined as illustrated in FIG. 4.

After selecting a neighbor node that is to transmit a service discovery request message, the wireless node proceeds to step 313 to transmit the service discovery request message to the selected neighbor node.

After that, the wireless node ends the present algorithm.

Hereinafter, a method for determining a maximum hop count of an advertisement message with consideration of broadcast depth of a service discovery request message in a service provide node is described.

FIG. 4 is a flowchart illustrating a procedure for updating a maximum hop count in a service provide node of a wireless communication system according to an embodiment of the present invention.

Referring to FIG. 4, the service provide node determines whether a service discovery request message is received in step 401.

When the service discovery request message is not received, the service provide node proceeds to step 407 to determine whether an advertisement message transmission period arrives.

In contrast, when the service discovery request message is received, the service provide node proceeds to step 403 to determine a hop count of the service discovery request message.

After determining the hop count of the service discovery request message, the service provide node proceeds to step 405 to determine a maximum hop count of an advertisement message with consideration of a hop count of the service discovery request message. For example, when the hop count of the service discovery request message is greater than an upper reference, the service provide node increases the maximum hop count of the advertisement message by a first reference value. In contrast, when the hop count of the service discovery request message is greater than a lower reference, the service provide node reduces the maximum hop count of the advertisement message by a second reference value. Here, the first reference value and the second reference value may be the same or different. For another example, when the hop count of the service discovery request message is greater than the maximum hop count of the advertisement message by twice or more, the service provide node may increase the maximum hop count of the advertisement message by two. When the hop count of the service discovery request message is greater than the maximum hop count of the advertisement message by the maximum hop count of the advertisement message, the service provide node may increase the maximum hop count of the advertisement message by one. In addition, when the maximum hop count of the advertisement message is greater than the hop count of the service discovery request message, the service provide node may reduce the maximum hop count of the advertisement message by one. In addition, when the maximum hop count of the advertisement message is greater than the hop count of the service discovery request message by twice or more, the service provide node may reduce the maximum hop count of the advertisement message by two.

The service provide node proceeds to step 407 to determine whether an advertisement message transmission period arrives.

When the advertisement message transmission period does not arrive, the service provide node proceeds to step 401 to determine whether a service discovery request message is received.

In contrast, when the advertisement message transmission period arrives, the service provide node proceeds to step 409 to broadcast an advertisement message to the neighborhood. That is, the service provide node transmits the advertisement message to all neighbor nodes located in a one-hop range. At this point, the advertisement message includes maximum hop count information determined in step 405.

After that, the service provide node ends the present algorithm.

In the above embodiment, the service provide node determines an advertisement message maximum hop count whenever a service discovery request message is received.

In an embodiment, the service provide node may determine the advertisement message maximum hop count with consideration of a hop count of a service discovery request message only when a hop count update period arrives.

Hereinafter, a construction of a node that transmits a service discovery request message to a neighbor node is described.

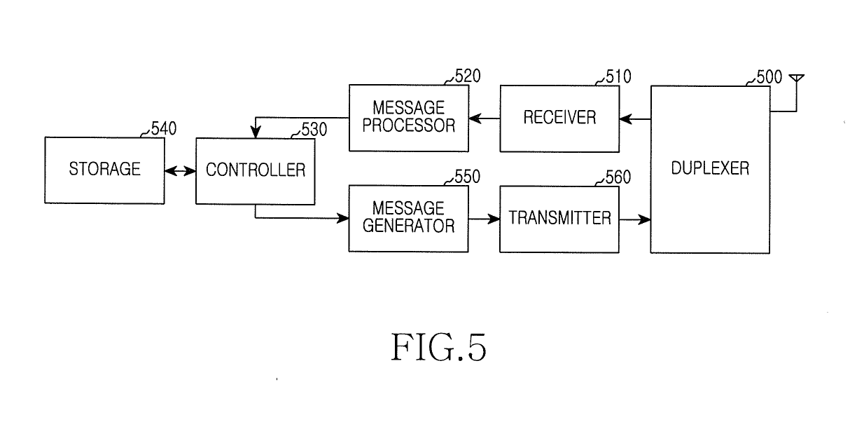

FIG. 5 is a block diagram illustrating a wireless node in a wireless communication system according to an embodiment of the present invention.

As illustrated in FIG. 5, the wireless node includes a duplexer 500, a receiver 510, a message processor 520, a controller 530, a storage 540, a message generator 550, and a transmitter 560.

The duplexer 500 transmits a transmission signal provided from the transmitter 560 via an antenna and provides a reception signal from the antenna to the receiver 510 according to a duplexing scheme.

The receiver 510 converts a Radio Frequency (RF) signal provided from the duplexer 500 into a baseband signal and demodulates the same. The receiver 510 may include an RF processing block, a demodulation block, a channel decode block, and the like. For example, the RF processing block converts an RF signal provided from the duplexer 500 into a baseband signal and outputs the same. The demodulation block includes a Fast Fourier Transform (FFT) operator for extracting data conveyed on each subcarrier from a signal provided from the RF processing block. The channel decode block includes a demodulator, a deinterleaver, a channel decoder.

The message processor 520 extracts control information from a signal provided from the receiver 510 to provide the same to the controller 530. For example, the message processor 520 extracts a service discovery request message or an advertisement message from a signal provided from the receiver 510 to provide the same to the controller 530.

The controller 530 controls an overall operation of the wireless node and transmission of a service discovery request message. At this point, when receiving a service discovery request message from the message processor 520, the controller 530 controls to transmit the service discovery request message as illustrated in FIG. 2 or FIG. 3. For example, when advertisement information corresponding to service information included in the service discovery request message does not exist among advertisement information stored in the storage 540, the controller 530 controls to broadcast the service discovery request message to the neighborhood. At this point, the controller 530 may control not to broadcast the service discovery request message with consideration of a broadcast range of the service discovery request message. Here, the broadcast range of the service discovery request message includes a broadcast depth of a service discovery request message and an accumulated broadcast time. For another example, when advertisement information corresponding to service information included in the service discovery request message exists among advertisement information stored in the storage 540, the controller 530 determines validity of the advertisement information. When the advertisement information is not valid, the controller 530 controls to broadcast the service discovery request message to the neighborhood. At this point, the controller 530 may control not to broadcast the service discovery request message with consideration of a broadcast range of the service discovery request message. In contrast, when the advertisement information is valid, the controller 530 controls to transmit the service discovery request message to at least one neighbor node including the advertisement information. At this point, the controller 530 may control to select only one neighbor node from neighbor nodes including the advertisement information and unicast the service discovery request message.

When receiving an advertisement message from the message processor 520, the controller 530 controls to store advertisement information included in the advertisement message in the storage 540.

The storage 540 stores the advertisement information included in the advertisement message provided from a neighbor node.

The message generator 550 generates a control message to be transmitted to a neighbor node under control of the controller 530. For example, the message generator 550 generates a service discovery request message to be broadcasted to the neighborhood under control of the controller 530. For another example, the message generator 550 may update a broadcast depth of the above received service discovery request message of a broadcast message type under control of the controller 530. For another example, the message generator 550 may generate a service discovery request message to be transmitted to a neighbor node including advertisement information under control of the controller 530.

The transmitter 560 encodes data to be transmitted to a neighbor node and a control message provided from the message generator 550, and converts them into RF signals to transmit the same to the duplexer 500. For example, the transmitter 560 may include a channel encode block, a modulation block, an RF processing block, and the like. Here, the channel encode block includes a modulator, an interleaver, and a channel encoder. The modulation block includes an Inverse Fast Fourier Transform (IFFT) operator for mapping a signal provided from the channel encode block to each subcarrier. The RF processing block converts a baseband signal provided from the modulation block into an RF signal to output the same to the duplexer 500.

Hereinafter, a construction of a service provide node that determines a maximum hop count of an advertisement message with consideration of a broadcast depth of a service discovery request message, and transmits the advertisement message is described.

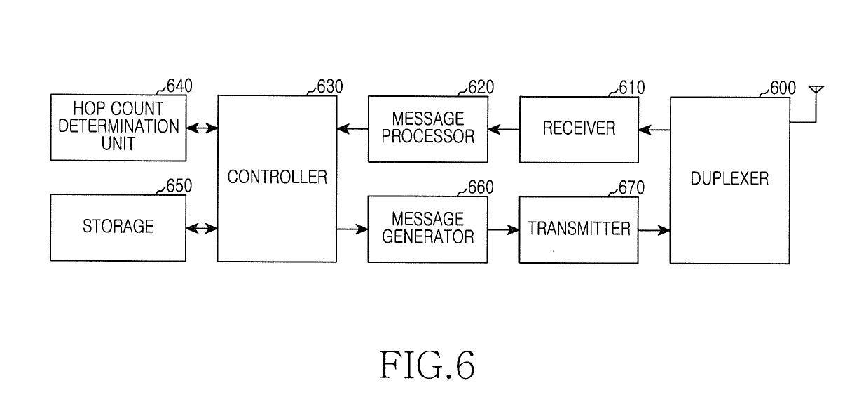

FIG. 6 is a block diagram illustrating a service provide node in a wireless communication system according to an embodiment of the present invention.

As illustrated in FIG. 6, the service provide node includes a duplexer 600, a receiver 610, a message processor 620, a controller 630, a hop count determination unit 640, a storage 650, a message generator 660, and a transmitter 670.

The duplexer 600 transmits a transmission signal provided from the transmitter 670 via an antenna and provides a reception signal from the antenna to the receiver 610 according to a duplexing scheme.

The receiver 610 converts a Radio Frequency (RF) signal provided from the duplexer 600 into a baseband signal and demodulates the same. The receiver 610 may include an RF processing block, a demodulation block, a channel decode block, and the like. For example, the RF processing block converts an RF signal provided from the duplexer 600 into a baseband signal and outputs the same. The demodulation block includes a Fast Fourier Transform (FFT) operator for extracting data conveyed on each subcarrier from a signal provided from the RF processing block. The channel decode block includes a demodulator, a deinterleaver, and a channel decoder.

The message processor 620 extracts control information from a signal provided from the receiver 610 to provide the same to the controller 630. For example, the message processor 620 extracts a service discovery request message from a signal provided from the receiver 610 to provide the same to the controller 630.

The controller 630 controls an overall operation of the service provide node and transmission of an advertisement message. For example, the controller 630 controls to transmit an advertisement message every advertisement message transmission period.

The hop count determination unit 640 determines a maximum hop count of an advertisement message with consideration of a hop count of a service discovery request message under control of the controller 630. For example, when a hop count of the service discovery request message is greater than an upper reference, the hop count determination unit 640 increases an advertisement message maximum hop count by a first reference value. In contrast, when the hop count of the service discovery request message is greater than a lower reference, the hop count determination unit 640 reduces the advertisement message maximum hop count by a second reference value. Here, the first reference value and the second reference value may be the same or different. For another example, when the hop count of the service discovery request message is greater than the advertisement message maximum hop count by twice or more, the hop count determination unit 640 may increase the advertisement message maximum hop count by two. For another example, when the hop count of the service discovery request message is greater than the advertisement message maximum hop count by the advertisement message maximum hop count, the hop count determination unit 640 may increase the advertisement message maximum hop count by one. For another example, when the advertisement message maximum hop count is greater than the hop count of the service discovery request message, the hop count determination unit 640 may reduce the advertisement message maximum hop count by one. For another example, when the advertisement message maximum hop count is greater than the hop count of the service discovery request message by twice or more, the hop count determination unit 640 may reduce the advertisement message maximum hop count by two.

The storage 650 stores driving information of the service provide node. For example, the storage 650 stores advertisement message maximum hop count information determined at the hop count determination unit 640.

The message generator 660 generates a control message to be transmitted to a neighbor node under control of the controller 630. For example, the message generator 660 generates an advertisement message to be broadcasted to the neighborhood under control of the controller 630. At this point, the advertisement message includes maximum hop count information determined by the hop count determination unit 640.

The transmitter 670 encodes data to be transmitted to a neighbor node and a control message provided from the message generator 660, and converts them into RF signals to transmit the same to the duplexer 600. For example, the transmitter 670 may include a channel encode block, a modulation block, an RF processing block, and the like. Here, the channel encode block includes a modulator, an interleaver, and a channel encoder. The modulation block includes an Inverse Fast Fourier Transform (IFFT) operator for mapping a signal provided from the channel encode block to each subcarrier. The RF processing block converts a baseband signal provided from the modulation block into an RF signal to output the same to the duplexer 600.

In the above construction, the controller 630 is a protocol controller, and may perform the function of the hop count determination unit 640. Separate configuration of the hop count determination unit 640 in an embodiment of the present invention is for separately describing each function. Therefore, in actual realization, all of the functions of the hop count determination unit 640 may be processed by the controller 630.

As described above, a maximum hop count that can transmit an advertisement message is determined with consideration of a hot count by which a discovery request message is transmitted at a service provide node of a wireless communication system that supports an SDP, so that a frequency in which a discovery request message is broadcasted may be reduced.

In addition, a node including advertisement information of a service provide node selects one node from one or more nodes including the advertisement information to transmit a discovery request message, so that a message overhead by the SDP may be reduced.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for determining a maximum hop count of an advertisement message in a service provide node of a wireless communication system that supports a Service Discovery Protocol, the method comprising:
when a service discovery request message is received from a neighbor node, determining a hop count of the service discovery request message; and
determining a maximum hop count of the advertisement message with consideration of the hop count of the service discovery request message,
wherein the hot count of the service discovery request message comprises a hop count from a request node that has generated the service discovery request message up to the service provide node.

2. The method of claim 1, wherein the determining of the maximum hop count comprises:
when the hop count of the service discovery request message is greater than a first reference value, increasing the maximum hop count by a first reference variable; and
when the hop count of the service discovery request message is less than a second reference value, reducing the maximum hop count by a second reference variable.

3. The method of claim 2, wherein the first reference variable and the second reference variable are the same or comprise a same value.

4. The method of claim 1, further comprising:
determining whether an advertisement message transmission period arrives; and
when the advertisement message transmission period arrives, broadcasting the advertisement message comprising the maximum hop count.

5. The method of claim 4, wherein the advertisement message comprises at least one of identification information of the service provide node, a hop count of the advertisement message, and the maximum hop count of the advertisement message.

6. A method for transmitting a message in a wireless node of a wireless communication system that supports a Service Discovery Protocol, the method comprising:
when a service discovery request message is received from a neighbor node, determining service information of the service discovery request message;
determining whether advertisement information corresponding to the service information is included; and
when the advertisement information corresponding to the service information is included, transmitting the service discovery request message to at least one neighbor node comprising the advertisement information,
wherein the service information comprises at least one of a service whose discovery is requested by a request node that has generated the service discovery request message, and service provide node information that provides the service, and
wherein the advertisement information comprises information of a service provide node included in an advertisement message provided by at least one neighbor node.

7. The method of claim 6, further comprising, when the advertisement information corresponding to the service information is not included, broadcasting the service discovery request message.

8. The method of claim 7, wherein the broadcasting of the service discovery request message comprises:
determining a broadcast range of the service discovery request message;
determining whether the service discovery request message is broadcastable with consideration of the broadcast range; and
when the service discovery request message is broadcastable, broadcasting the service discovery request message to a neighborhood,
wherein the broadcast range comprises at least one of a broadcast depth, and an accumulated broadcast time.

9. The method of claim 6, wherein the transmitting of the service discovery request message comprises:
when at least two neighbor nodes comprising the advertisement information exist, selecting one neighbor node from the at least two neighbor nodes; and
transmitting the service discovery request message to the selected neighbor node.

10. The method of claim 9, wherein the selecting of one neighbor node comprises:
selecting one neighbor node with consideration of at least one of a hop count that has received an advertisement message via a neighbor node and a message overhead of a relevant neighbor node.

11. An apparatus for determining a maximum hop count of an advertisement message in a service provide node of a wireless communication system that supports a Service Discovery Protocol, the apparatus comprising:
a receiver configured to receive a signal; and
a hop count determination unit configured, when a service discovery request message is received from a neighbor node via the receiver, to determine the maximum hop count of the advertisement message with consideration of a hop count of the service discovery request message,
wherein the hop count of the service discovery request message comprises a hop count from a request node that has generated the service discovery request message up to the service provide node.

12. The apparatus of claim 11, wherein when the hop count of the service discovery request message is greater than a first reference value, the hop count determination unit increases the maximum hop count by a first reference variable, and
when the hop count of the service discovery request message is less than a second reference value, the hop count determination unit reduces the maximum hop count by a second reference variable.

13. The apparatus of claim 12, wherein the first reference variable and the second reference variable are the same or comprise a same value.

14. The apparatus of claim 11, further comprising:
a controller configured, when an advertisement transmission period arrives, to control to transmit an advertisement message comprising the maximum hop count; and
a transmitter configured to transmit the advertisement message under control of the controller.

15. The apparatus of claim 14, wherein the transmitter transmits the advertisement message comprising at least one of identification information of the service provide node, a hop count of the advertisement message, and the maximum hop count of the advertisement message.

16. An apparatus for transmitting a message in a wireless node of a wireless communication system that supports a Service Discovery Protocol, the apparatus comprising:
a receiver configured to receive a signal;
a controller configured, when a service discovery request message is received from a neighbor node via the receiver, to determine whether advertisement information corresponding to service information of the service discovery request message is included, and when the advertisement information corresponding to the service information is included, to control to transmit the service discovery request message to at least one neighbor node comprising the advertisement information; and
a transmitter configured to transmit the service discovery request message under control of the controller;
wherein the service information comprises at least one of a service whose discovery is requested by a request node that has generated the service discovery request message, and service provide node information that provides the service, and
wherein the advertisement information comprises information of a service provide node included in an advertisement message provided by at least one neighbor node.

17. The apparatus of claim 16, wherein when the advertisement information corresponding to the service information is not included, the controller controls to broadcast the service discovery request message.

18. The apparatus of claim 17, wherein the controller determines whether the service discovery request message is broadcastable with consideration of a broadcast range of the service discovery request message, and when the service discovery request message is broadcastable, the controller controls to broadcast the service discovery request message to a neighborhood, and
the broadcast range comprises at least one of a broadcast depth and an accumulated broadcast time.

19. The apparatus of claim 16, wherein when at least two neighbor nodes comprising the advertisement information exist, the controller selects one neighbor node from the at least two neighbor nodes, and controls to transmit the service discovery request message to the selected neighbor node.

20. The apparatus of claim 19, wherein the controller selects one neighbor node with consideration of at least one of a hop count that has received an advertisement message via a neighbor node and a message overhead of a relevant neighbor node.
